(19) United States
(12) Patent Application Publication
(10) Pub. No.: US 2026/0328651 A1
(43) Pub. Date: Oct. 22, 2026

(54) SYSTEM AND METHOD FOR TRAILER TIRE PRESSURE MONITORING

(71) Applicant: Torc Robotics, Inc., Blacksburg, VA (US)

(72) Inventor: Fridtjof Stein, Ostfildern (DE)

(21) Appl. No.: 19/186,275

(22) Filed: Apr. 22, 2025

(51) Int. Cl. G01M 17/02; B60W 60/00; G01L 17/00; G07C 5/00

(52) U.S. Cl. CPC G01M 17/025; B60W 60/0015; G01L 17/00; G07C 5/008; B60W 2530/20

(57) ABSTRACT

A disclosed system includes an autonomous vehicle attached with a trailer, a plurality of sensors, and a computing system including at least one memory configured to store machine executable instructions, and at least one processor configured to execute the machine executable instructions to receive sensor data from the plurality of sensors; detect a trailer condition based on the sensor data; based on the trailer condition, initiate maneuvering of the autonomous vehicle to stop in a safe position; deploy a mobile robot, when stopped, from a bay of the autonomous vehicle to collect acoustic data associated with a plurality of wheels of the trailer; receive the acoustic data; process the acoustic data to determine a wheel of the plurality of wheels exhibits low tire air pressure; and initiate a safety maneuver of the autonomous vehicle based upon the low tire air pressure.

### TECHNICAL FIELD

The field of the disclosure relates to autonomous vehicles and, more specifically, systems and methods of monitoring trailer tire pressure.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data or Global Navigation Satellite Systems (GNSS) data. Behaviors and planning (or behaviors and motion planning (BMP)) technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Tractor and trailer tire pressure are important elements of safe operation of an autonomous truck. The tractor is generally equipped with sensors for monitoring air pressure of tires of the tractor. However, most trailers are not equipped with tire pressure monitoring sensors for monitoring air pressure of tires of the trailer. Accordingly, absent a driver, when a trailer tire is experiencing an air pressure related problem, the problem cannot be easily detected and immediately reported to an autonomy computing system to mitigate.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system including an autonomous vehicle attached with a trailer, a plurality of sensors, and a computing system including at least one memory configured to store machine executable instructions, and at least one processor coupled to the at least one memory and configured to execute the machine executable instructions is disclosed. The machine executable instructions configure the at least one processor to: receive sensor data from the plurality of sensors; detect a trailer condition based on the sensor data; based on the trailer condition, initiate maneuvering of the autonomous vehicle to stop in a safe position; deploy a mobile robot, when stopped, from a bay of the autonomous vehicle to collect acoustic data associated with a plurality of wheels of the trailer; receive the acoustic data; process the acoustic data to determine a wheel of the plurality of wheels exhibits low tire air pressure; and initiate a safety maneuver of the autonomous vehicle based upon the low tire air pressure.

In another aspect, an autonomy computing system for an autonomous vehicle attached with a trailer is disclosed. The autonomy computing system includes at least one memory configured to store machine executable instructions, and at least one processor coupled to the at least one memory and configured to execute the machine executable instructions to configure the at least one processor to: receive sensor data from a plurality of sensors of the autonomous vehicle during operation; detect a trailer condition based on the sensor data; based on the trailer condition, initiate maneuvering of the autonomous vehicle to stop in a safe position; deploy a mobile robot, when stopped, from a bay of the autonomous vehicle to collect acoustic data associated with a plurality of wheels of the trailer; receive the acoustic data; process the acoustic data to determine a wheel of the plurality of wheels exhibits low tire air pressure; and initiate a safety maneuver of the autonomous vehicle based upon the low tire air pressure.

In yet another aspect, a computer-implemented method is disclosed. The computer-implemented method includes receiving sensor data from a plurality of sensors of an autonomous vehicle during operation; detecting a trailer condition based on the sensor data of a trailer coupled with the autonomous vehicle; based on the trailer condition, initiating maneuvering of the autonomous vehicle to stop in a safe position; deploying a mobile robot, when stopped, from a bay of the autonomous vehicle to collect acoustic data associated with a plurality of wheels of the trailer; receiving the acoustic data; processing the acoustic data to determine a wheel of the plurality of wheels exhibits low tire air pressure; and initiating a safety maneuver of the autonomous vehicle based upon the low tire air pressure.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is a block diagram of an example tire air pressure monitoring module shown in FIG. 2;

FIGS. 5A to 5G each illustrate an example autonomous vehicle with a tractor, a trailer, and a mobile robot in various stages of trailer tire air pressure monitoring; and

FIG. 6 is a flow-chart of an example method of monitoring trailer tire air pressure.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

As described herein, in an autonomous vehicle having a tractor coupled with a trailer, generally trailers are not equipped with sensors beyond the minimal requirements for a standard trailer. More specifically, trailers often lack sensors for measuring air pressure of trailer tires. Typically, a sensor attached for monitoring tire air pressure in a tractor tire sends signals about the measured or monitored air pressure on a regular basis to the autonomy computing system. The autonomy computing system generates an alarm or alert, and takes actions required to ensure safe operation of the autonomous vehicle and others in the surrounding environment of the autonomous vehicle. However, if a tire of the trailer attached with the tractor has low tire air pressue, absent a driver, the low tire air pressure is not detected and reported for an action to safeguard the autonomous vehicle and others in the surrounding environment of the autonomous vehicle.

The disclosed systems and methods employ secondary signals to detect a condition of a tire of the trailer attached with the tractor, such as low tire air pressure. Secondary signals may include acceleration related sensor signals, deceleration related sensor signals, or sensor signals related to swaying of the trailer attached with the tractor, etc. Such secondary signals or inertial data are processed by the autonomy computing system, which can be trained to detect tire air pressure related conditions for the wheel and tire of the trailer using a neural network trained with inertial data. Inertial data, as described herein, includes data associated with acceleration, deacceleration, and angular velocity of the autonomous vehicle corresponding to various trailer tire conditions. Based upon the received secondary signals, or inertial data, the autonomy computing system may determine the condition a trailer tire, and when the determined condition indicates low tire air pressure of the trailer tire, the autonomy computing system may determine to maneuver the autonomous vehicle to stop at a nearest safe position, for example, a nearest truck stop or a roadside shoulder.

Upon stopping at a safe position, a mobile robot stored in a tractor space, or bay, would be deployed. The mobile robot would then travel to and check all tires of the trailer attached with the truck with a mechanical ping device (MPD). The MPD, when actuated, produces a detectible acoustic response. The acoustic response is processed by the autonomy computing system, or transmitted to a remote application server for processing, to determine, for example, tire air pressure. In certain embodiments, the processing employs a neural network trained, for example, with acoustic data corresponding to various tire air pressures for diagnosing tire conditions.

Based upon the processed acoustic response, or acoustic data, the autonomy computing system can request additional assistance for a repair, or determine to continue the trip if it is determined that the observed swaying of the trailer did not originate from an impaired or damaged tire.

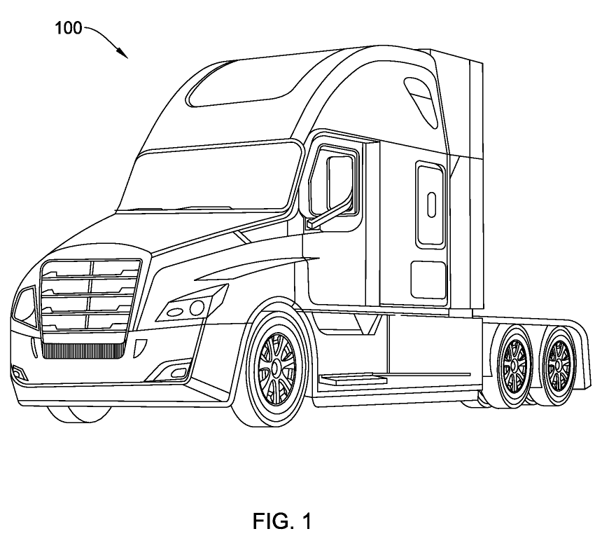

Various embodiments are described in detail using FIGS. 1 to 6.

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

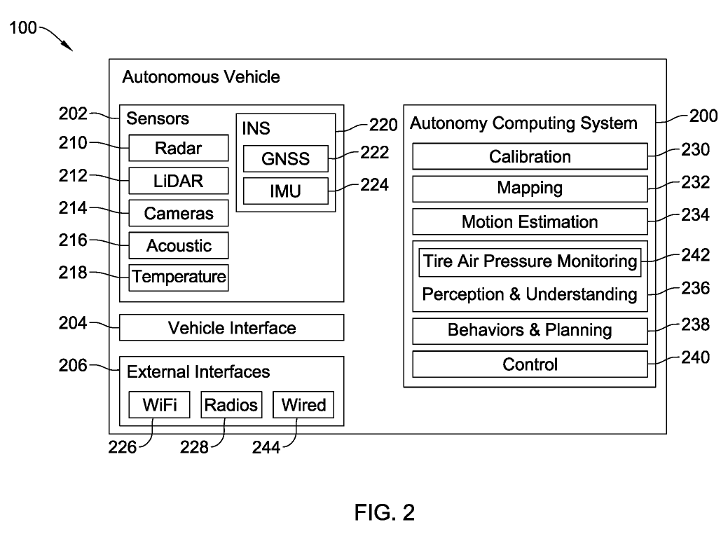

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

Cameras 214 may have temperature sensors 218 (e.g., one or more of negative temperature coefficient (NTC) thermistors, resistance temperature detectors (RTDs), thermocouples, or semiconductor-based integrated (IC) sensors) positioned on an external surface, or an internal surface, or both, to measure temperature on a camera lens surface of each of cameras 214. Additionally, temperature sensors 218 may be positioned on other areas of the autonomous vehicle 100, e.g., to measure ambient temperature.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and tire air pressure monitoring module 242. The tire air pressure monitoring module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The tire air pressure monitoring module 242 may include one or more neural networks configured to detect tire air pressure related conditions in trailer tires. For example, a neural network model may be trained on inertial data and employed during operation to process IMU sensor data to determine conditions of the trailer tires. Additionally, for example, another neural network model may be trained on acoustic data and employed during tire pressure monitoring to process acoustic data collected for each trailer tire to determine tire air pressure. Additionally, or alternatively, the tire air pressure monitoring module 242 may also determine which corrective action should be taken based upon the determined tire air pressure condition.

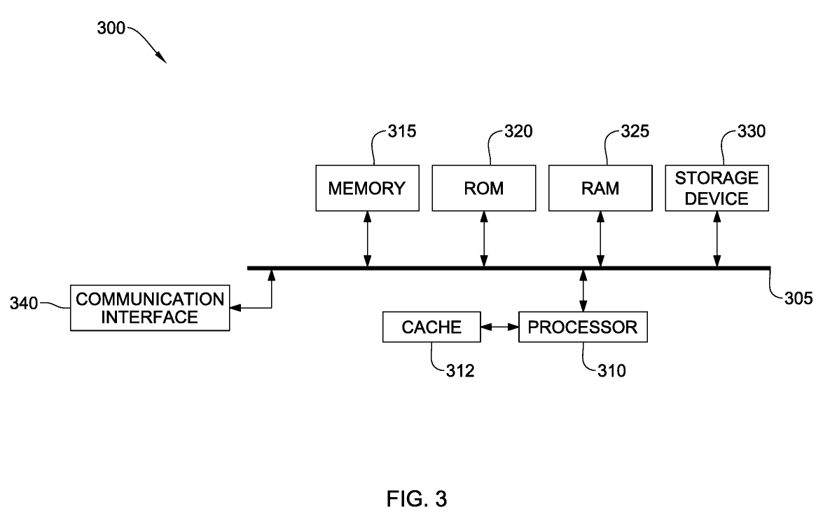

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. Additionally, or alternatively, computing system 300 may be embodied in one or more remote application servers for processing data received from one or more autonomous vehicles. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

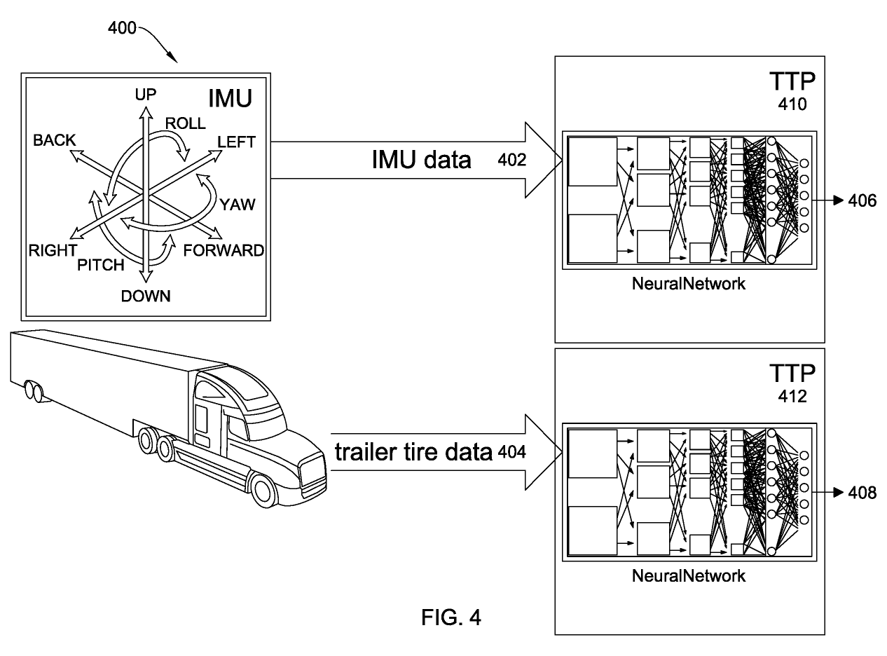

FIG. 4 illustrates a block diagram 400 of an example tire air pressure monitoring module 242 shown in FIG. 2. The tire air pressure monitoring module 242 receives IMU data 402 and trailer tire data 404 as inputs. IMU data may be generated, for example, by IMU 224 shown in FIG. 2. The tire air pressure monitoring module 242, as shown in FIG. 4, can include a neural network 410 trained with inertial data, as described herein, and configured to generate an output 406. The output 406 corresponds with whether the autonomous vehicle needs to be moved to a safe area for evaluating or checking tire air pressure using a mobile robot as described herein.

Additionally, or alternatively, the tire air pressure monitoring module 242 may employ another neural network-based model 412 for determining whether any tire or a wheel is having a tire air pressure related issue based upon acoustic data 404 (or trailer tire data 404) received from a mobile robot as described herein. By way of an example, the neural network-based model 412 may be a machine learning (ML) model, a convolutional neural network (CNN), a transformer based neural network, a diffusion model, and/or other ML model that is trained using acoustic data and other test track data as described below. The neural network-based model 410 or neural network-based model 412 may be trained using backpropagation techniques for reducing any difference between an output of the tire air pressure monitoring module 242 and an actual output. Backpropagation techniques are supervised machine learning algorithms that are used for training neural networks, for example, for adjusting weights of connections between neurons by computing a gradient of an error function with respect to the weights and then updating the weights to minimize the error. Various algorithms such as gradient descent, stochastic gradient descent, etc., may be used for adjusting weights and biases of the neural network-based model 410 or 412 of tire air pressure monitoring module 242. An output 408 of the neural network-based 412 may suggest whether a wheel of the trailer (or a wheel of the tractor of the autonomous vehicle 100) is experiencing any tire air pressure related issue, and based on which a corrective action to increase safety of the autonomous vehicle may be performed.

The neural network-based models 410 and 412 of tire air pressure monitoring module 242 may have multiple layers including an input layer, one or more hidden layers, and an output layer. The test track data, described herein, may include collection of recorded test track data with different stages of tire conditions such as tread wear (e.g., tread depth, uneven wear, etc.), tire damage (e.g., cuts, bulges, cracks, etc.), and issues related to underinflation or overinflation, etc. Additionally, the test track data may also include test track data in which there is no tire related problem. The test track data may also include data corresponding to different trailer load configurations and data corresponding to different driving scenarios. Various different driving scenarios may include driving fast, driving slow, driving on a curved road, driving uphill, driving downhill, etc.

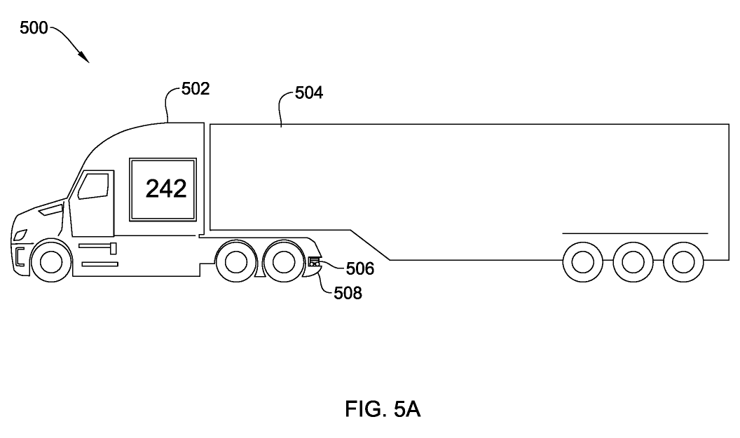

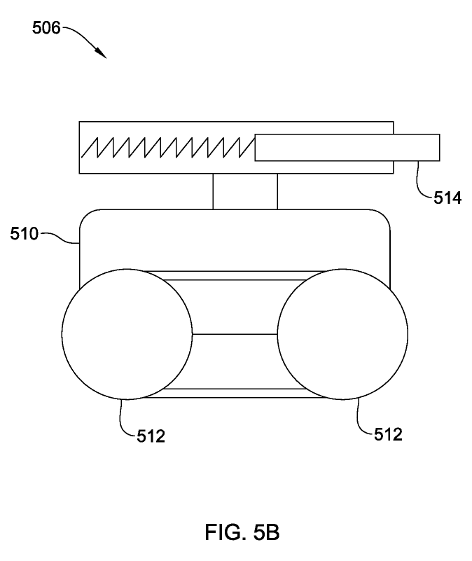

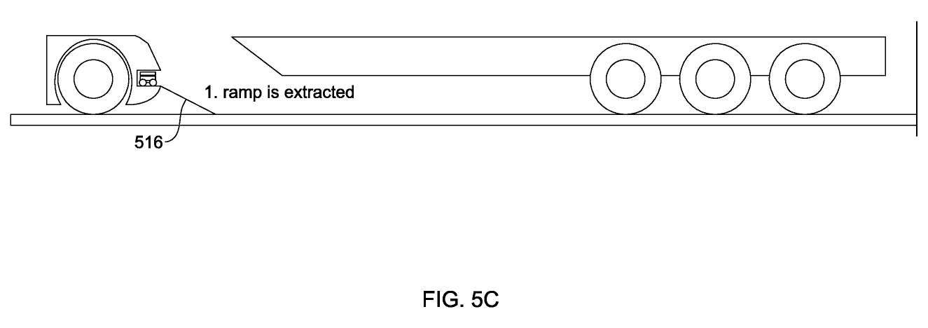

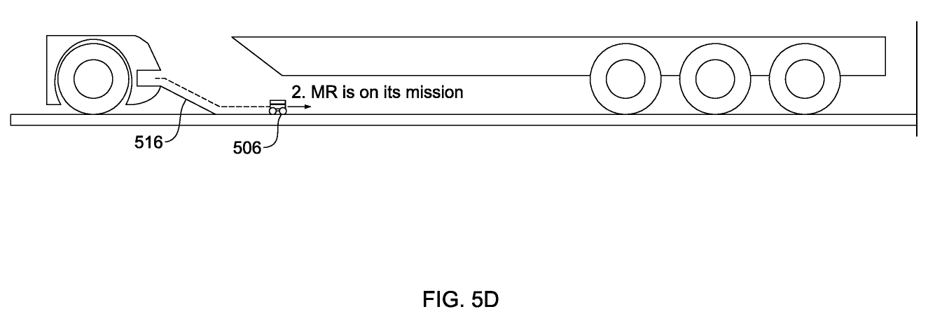

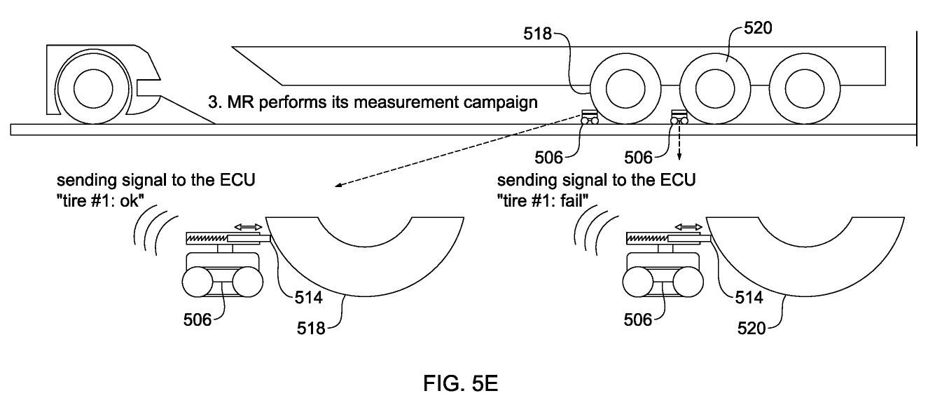

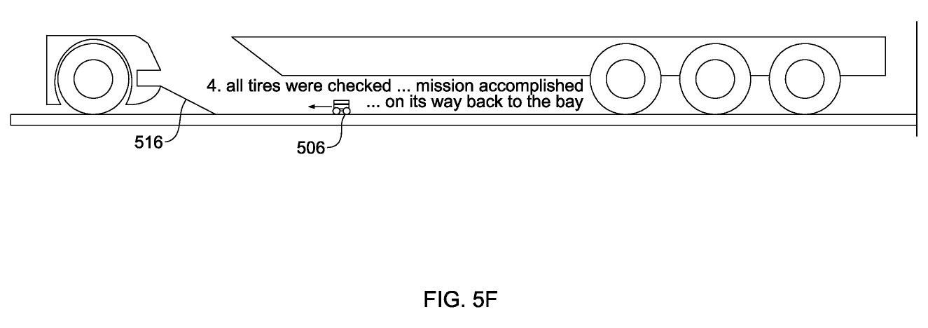

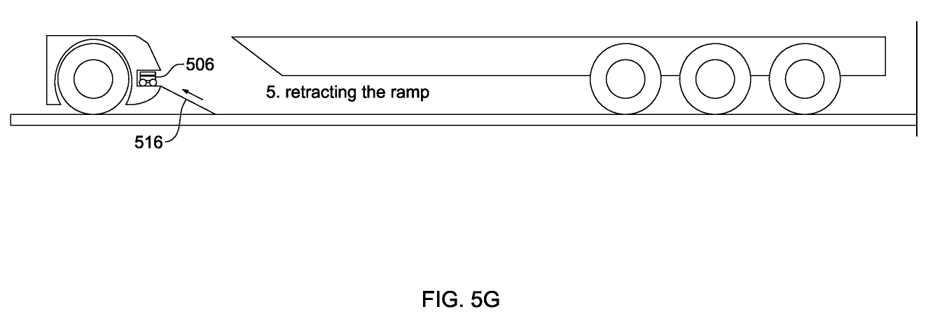

The neural network-based model 412 may be trained to analyze sound waves generated by the mobile robot (as described herein using FIGS. 5A to 5G) to determine whether a wheel is experiencing any tire air pressure related issue. In particular, the neural network-based model 412 is trained to analyze acoustic frequency response corresponding to vibrations and sound waves generated using the mobile robot.

FIGS. 5A to 5G each illustrate an example autonomous vehicle 500 with a tractor 502, a trailer 504, and a mobile robot 506 in different stages of tire air pressure monitoring. The mobile robot 506 is stored in a bay 508 of the tractor 502. The mobile robot 506 is shown in FIG. 5B as having a body 510, wheels 512, and a knocking or frequency-analysis device (also referenced herein as a mechanical ping device) 514. The mobile robot 506, like an autonomous vehicle, is a self-driving robot, which is deployed from the bay 508 when the autonomous vehicle 500 stops at a safe position such as parking lot, or a shoulder. A ramp 516 is extended, as shown in FIG. 5C, for the mobile robot 506 to check for or detect tire air pressure related conditions.

The mobile robot 506 drives down the ramp 516 and automatically drives towards wheels of trailer 504 as shown in FIG. 5D. As shown in FIG. 5E, the mobile robot 506 upon reaching at a tire 518, for example, use the knocking device 514 to hit at different parts of the tire 518 with different force or pressure.

In some embodiments, and by way of an example, the mobile robot 506 may be height adjustable and extend its height to reach to upper parts of the tire 518. Acoustic signals, or acoustic responses, are generated upon checking tire air pressure using the knocking device 514. The mobile robot 506 may transmit acoustic data representing the acoustic responses to the tire air pressure monitoring module 242 for determining whether the tire 518 has any air pressure related conditions, e.g., low air pressure.

In some embodiments, the mobile robot 506 may process the acoustic data using a module similar to the tire air pressure monitoring module 242 embodied in the mobile robot 506 and determine whether the tire 518 has any air pressure related conditions. The mobile robot 506 accordingly can send a signal to the tire air pressure monitoring module 242 that the tire 518 has no air pressure related condition.

Alternatively, in certain embodiments, the acoustic data may be transmitted to mission control for processing, for example, on a remote application server, to determine whether a tire has any air pressure related conditions and, based upon the processing of the acoustic data by mission control, determine whether the autonomous vehicle should continue its trip as planned or send any additional help to the site of autonomous vehicle.

Referring to FIG. 5E, upon checking tire 518, the mobile robot 506 moves to a next tire 520. Using the knocking device 514, the mobile robot 506 checks tire air pressure related conditions for the tire 520. As described herein, the mobile robot transmits acoustic data to the tire air pressure monitoring module 242 for determining whether the tire 520 has any air pressure related conditions. Alternatively, the mobile robot 506 may process the acoustic data and determine whether the tire 520 has any air pressure related conditions. The mobile robot 506 accordingly sends a signal to the tire air pressure monitoring module 242, for example, indicating the tire 520 is exhibiting air pressure related conditions, e.g., low tire air pressure.

As shown in FIG. 5F, upon checking all tires of the trailer 504, the mobile robot 506 may return to the bay 508. When the mobile robot 506 is secured again in the bay 508, as shown in FIG. 5G, the ramp 516 is retracted. Based upon processing of acoustic data by the mobile robot 506 or the tire air pressure monitoring module 242, additional help may be sought, or the autonomous vehicle may continue on its trip as planned.

In some examples, the mobile robot 506 may be controlled or operated wirelessly or via cables by the tire air pressure monitoring module 242, the autonomy computing system 200 shown in FIG. 2, or mission control (not shown in FIGS. 5A-5G). Alternatively, the mobile robot 506 may be an autonomously operated mobile robot 506. The mobile robot 506 remains in communication with the tire air pressure monitoring module 242, the autonomy computing system 200 shown in FIG. 2, or mission control (not shown in FIGS. 5A-5G). In certain embodiments, where the mobile robot is battery operated, the bay 508 may be configured to charge the mobile robot 506.

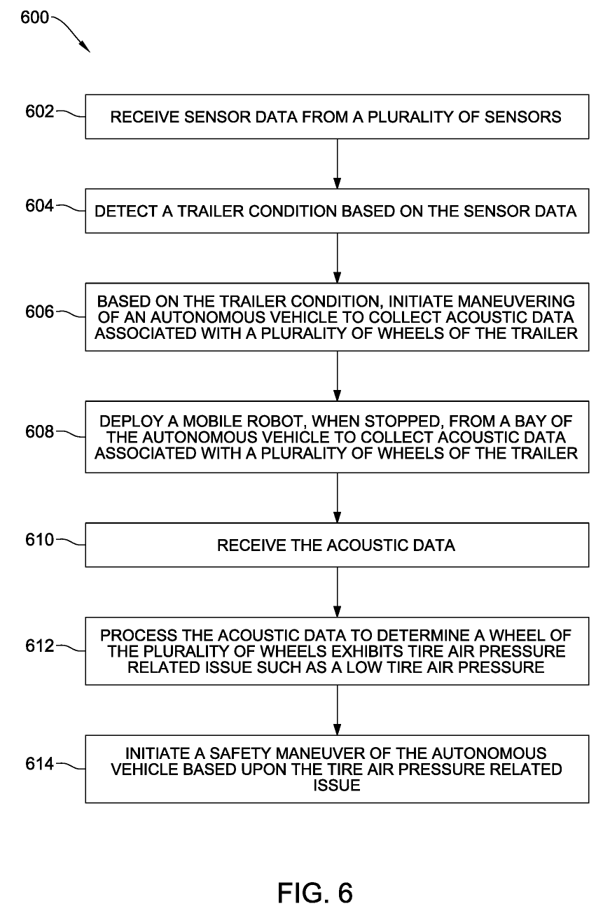

FIG. 6 illustrates a flow-chart 600 of an example method of operations for checking air pressure related conditions in trailer tires, and taking corrective actions required based on the identified air pressure related conditions. The method operations are performed by the tire air pressure monitoring module 242 shown in FIG. 2, the computing system 300 shown in FIG. 3, or mission control (not shown). The method operations include receiving 602 sensor data from a plurality of sensors of an autonomous vehicle during operation. The sensor data from the plurality of sensors of the autonomous vehicle include acceleration data, deceleration data, or trailer sway data. If there is a tire air pressure related issue, then the acceleration or deceleration of the autonomous vehicle and/or the autonomous vehicle coupled with the trailer would be hindered due to reduced traction and increased rolling resistance in an underinflated tire scenario. Similarly, in an overinflated tire scenario, can also affect acceleration or deceleration of the autonomous vehicle and/or the autonomous vehicle coupled with the trailer. Additionally, the underinflated tire scenario could significantly contribute to trailer swaying.

The method operations include detecting 604 a trailer condition based on the sensor data. The trailer condition may be detected using a neural network-based model, for example, a convolution neural network (CNN) based model or like, for processing the sensor data associated with acceleration, deceleration, etc. Based upon the sensor data associated with acceleration, deceleration, etc., a likely tire air pressure related issue may be suspected.

Based upon the suspected tire air pressure related issue or the trailer condition, the method operations include initiating 606 maneuvering of the autonomous vehicle to stop in a safe position, and deploying 608 a mobile robot, when the autonomous vehicle is stopped in the safe position. The mobile robot may be deployed from a bay of the autonomous vehicle to collect acoustic data associated with a plurality of wheels of the trailer.

As described herein using FIGS. 5A to 5G, the method operations including receiving 610 the acoustic data associated with one or more wheels of the plurality of wheels of the trailer. The acoustic data is processed 612, for example, using a neural network-based model trained using backpropagation techniques, as described herein, to determine whether a wheel of the plurality of wheels exhibits a tire air pressure related issue (for example, a low tire air pressure, a high tire air pressure) or a damage to a tire to initiate 614 a safety maneuver of the autonomous vehicle based upon the low tire air pressure. The neural network-based model is trained using backpropagation techniques using data representing a plurality of tire conditions including staged tire problems, no tire problems, a plurality of load configurations of the trailer, and a plurality of driving conditions.

The method operations also include initiating return of the mobile robot to the bay upon checking all wheels of the plurality of wheels of the trailer. Additionally, or alternatively, the acoustic data may be transmitted to a remote application server (e.g., mission control) for processing and receiving an indication, from the remote application server, that a wheel is exhibiting low tire air pressure to perform the safety maneuver of the autonomous vehicle.

Accordingly, described embodiments provide certain advantages including, but not limited to, avoiding one or more of: reduced handling and stability due to swaying and unpredictable handing; increased fuel consumption; tire damage; tire failure; heat build-up; tire blow outs; tire tread separation; loss of control for the autonomous vehicle; damage to the trailer, cargo, or others in the environment of the autonomous vehicle; reduced braking efficient; overloading of other tires; and consequences of an underinflated tire. While the embodiments are described herein for checking tire air pressure related conditions for trailer tires, the embodiments are also applicable for checking tire air pressure related conditions for a tractor of the autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for ‎purposes of description, a wide variety of alternate and/or equivalent embodiments or ‎implementations calculated to achieve the same purposes may be substituted for the ‎embodiments shown and described without departing from the scope of the present disclosure. ‎This application is intended to cover any adaptations or variations of the embodiments ‎discussed herein, including the implementation or utilization of components of the systems or steps independently and separately from other described components or steps. Therefore, it is manifestly intended that embodiments described herein be ‎limited only by the claims.

What is claimed is:

1. A system comprising:
an autonomous vehicle attached with a trailer;
a plurality of sensors; and
a computing system comprising at least one memory configured to store machine executable instructions, and at least one processor coupled to the at least one memory and configured to execute the machine executable instructions to configure the at least one processor to:
receive sensor data from the plurality of sensors;
detect a trailer condition based on the sensor data;
based on the trailer condition, initiate maneuvering of the autonomous vehicle to stop in a safe position;
deploy a mobile robot, when stopped, from a bay of the autonomous vehicle to collect acoustic data associated with a plurality of wheels of the trailer;
receive the acoustic data;
process the acoustic data to determine a wheel of the plurality of wheels exhibits low tire air pressure; and
initiate a safety maneuver of the autonomous vehicle based upon the low tire air pressure.

2. The system of claim 1, wherein the sensor data from the plurality of sensors of the autonomous vehicle include acceleration data, deceleration data, or trailer sway data.

3. The system of claim 1, wherein the at least one processor is further configured to process the acoustic data using a neural network-based model.

4. The system of claim 3, wherein the neural network-based model is trained using backpropagation techniques.

5. The system of claim 3, wherein the neural network-based model is trained using data representing a plurality of tire conditions including staged tire problems, no tire problems, a plurality of load configurations of the trailer, and a plurality of driving conditions.

6. The system of claim 1, wherein the at least one processor is further configured to initiate return of the mobile robot to the bay upon checking all wheels of the plurality of wheels of the trailer.

7. The system of claim 1, wherein the at least one processor is further configured to:
transmit the acoustic data to a remote application server for processing; and
receive, from the remote application server, an indication the wheel is exhibiting low tire air pressure.

8. An autonomy computing system for an autonomous vehicle attached with a trailer, the autonomy computing system comprising:
at least one memory configured to store machine executable instructions; and
at least one processor coupled to the at least one memory and configured to execute the machine executable instructions to configure the at least one processor to:
receive sensor data from a plurality of sensors of the autonomous vehicle during operation;
detect a trailer condition based on the sensor data;
based on the trailer condition, initiate maneuvering of the autonomous vehicle to stop in a safe position;
deploy a mobile robot, when stopped, from a bay of the autonomous vehicle to collect acoustic data associated with a plurality of wheels of the trailer;
receive the acoustic data;
process the acoustic data to determine a wheel of the plurality of wheels exhibits low tire air pressure; and
initiate a safety maneuver of the autonomous vehicle based upon the low tire air pressure.

9. The autonomy computing system of claim 8, wherein sensor data from the plurality of sensors of the autonomous vehicle include acceleration data, deceleration data, or trailer sway data.

10. The autonomy computing system of claim 8, wherein the at least one processor is further configured to process the acoustic data using a neural network-based model.

11. The autonomy computing system of claim 10, wherein the neural network-based model is trained using backpropagation techniques.

12. The autonomy computing system of claim 10, wherein the neural network-based model is trained using data representing a plurality of tire conditions including staged tire problems, no tire problems, a plurality of load configurations of the trailer, and a plurality of driving conditions.

13. The autonomy computing system of claim 8, wherein the at least one processor is further configured to initiate return of the mobile robot to the bay upon checking all wheels of the plurality of wheels of the trailer.

14. The autonomy computing system of claim 8, wherein the at least one processor is further configured to:
transmit the acoustic data to a remote application server for processing; and
receive, from the remote application server, an indication the wheel is exhibiting low tire air pressure.

15. A computer implemented method comprising:
receiving sensor data from a plurality of sensors of an autonomous vehicle during operation;
detecting a trailer condition based on the sensor data of a trailer coupled with the autonomous vehicle;
based on the trailer condition, initiating maneuvering of the autonomous vehicle to stop in a safe position;
deploying a mobile robot, when stopped, from a bay of the autonomous vehicle to collect acoustic data associated with a plurality of wheels of the trailer;
receiving the acoustic data;
processing the acoustic data to determine a wheel of the plurality of wheels exhibits low tire air pressure; and
initiating a safety maneuver of the autonomous vehicle based upon the low tire air pressure.

16. The computer-implemented method of claim 15, wherein sensor data from the plurality of sensors of the autonomous vehicle include acceleration data, deceleration data, or trailer sway data.

17. The computer-implemented method of claim 15, further comprising processing the acoustic data using a neural network-based model, and wherein the neural network-based model is trained using backpropagation techniques.

18. The computer-implemented method of claim 17, further comprising training the neural network-based model using data representing a plurality of tire conditions including staged tire problems, no tire problems, a plurality of load configurations of the trailer, and a plurality of driving conditions.

19. The computer-implemented method of claim 15, further comprising initiating return of the mobile robot to the bay upon checking all wheels of the plurality of wheels of the trailer.

20. The computer-implemented method of claim 15, further comprising transmitting the acoustic data to a remote application server for processing and receiving an indication the wheel is exhibiting low tire air pressure.
